(19) United States
(12) Patent Application Publication
(10) Pub. No.: US 2014/0189520 A1
(43) Pub. Date: Jul. 3, 2014

(54) DIGITAL CHECKLIST

(71) Applicant: FLUKE CORPORATION, (US)

(72) Inventors: Robert C. Crepps, Snohomish, WA (US); David C. Dyck, Lake Forest Park, WA (US); Nikola Mrvaljevic, Seattle, WA (US)

(73) Assignee: FLUKE CORPORATION, Everett, WA (US)

(21) Appl. No.: 13/837,888

(22) Filed: Mar. 15, 2013

Related U.S. Application Data
(60) Provisional application No. 61/747,903, filed on Dec. 31, 2012.

(51) Int. Cl. G06F 3/0484

(52) U.S. Cl. CPC G06F 3/0484
USPC 715/738

(57) ABSTRACT

A digital checklist system includes an electronic calibration and measurement device and a computer-readable medium having computer-executable instructions stored thereon that, if executed by one or more processors of a computing device, cause the computing device to perform actions for managing a digital checklist The actions include creating a digital checklist having at least one unique prompt, selecting the digital checklist for uploading onto the electronic calibration and measurement device, and downloading data input into the electronic calibration and measurement device in response to the at least one unique prompt. The system further includes a network location for facilitating communication between the electronic calibration and measurement device and the computing device.

### CROSS-REFERENCE TO RELATED APPLICATION

This application claims the benefit of U.S. Provisional Application No. 61/747,903, filed Dec. 31, 2012, the disclosure of which is incorporated herein by reference.

### BACKGROUND

In various industrial environments, such as in oil refineries, chemical plants, manufacturing facilities, or other situations or environments where precautions must be taken, a checklist of procedures, measurements, inspections, and other tasks is completed on a regular basis to help ensure safety and optimal operation of equipment. For instance, various regulations (such as ISO 9000, FDA, EPA, OSHA regulations, etc.) may require periodic inspection, calibration, and measurement of devices and equipment, as well as documentation of the inspection, calibrations, measurements, and other tasks. Such tasks, once defined, are often documented in a customized, physical checklist (such as a piece or pad of paper), and the operator must document with a pen or pencil the tasks carried out, the measurements taken, etc. At a later time/date, the checklist data is typically uploaded to a computer database or similar for storage and archival of results.

It can be cumbersome and inefficient to use a piece of paper to outline the tasks and document the tasks. For instance, if an operator needs to inspect a transmitter for condensation, surrounding rust or fraying of wires, etc., it can be difficult to make notes on the checklist while efficiently and safely carrying out the tasks. As another example, an operator may need to go up scaffolding, be lifted on a forklift, etc., where it can be difficult to carry a checklist and pen in addition to any test or calibration equipment. Furthermore, these situations can be further complicated in harsh environments, such in as rain or snow storms.

A device called a documenting process calibrator (DPC), available from Fluke Corporation of Everett, Wash., may be used to calibrate and document calibration steps and calibration results of various equipment and procedures. For instance, DPC's, such as the Fluke 750 series documenting process calibrators, are used to test instruments and equipment in various industrial environments, such as by sourcing, simulating, and measuring pressure, temperature, and electrical signals. The DPC is used to run various calibration procedures on equipment and devices, and it stores the calibration results within the DPC for downloading to a computer at a later date. In this manner, the operator does not need to write down the calibration results or manually transfer the results to an electronic database for storage.

A DPC is typically used in harsh or potentially dangerous industrial environments where it would be difficult to both measure and calibrate equipment and record the results at the same time. The DPC records all test results for which the DPC was used to make the calibration or measurement. However, any additional checklist procedures must be done separately, requiring the operator to carry a physical checklist with him/her, record the results or tasks, and thereafter manually transfer the data onto a computer or similar device. Such a procedure is inefficient and cumbersome for the operator. Thus, there is a need for an improved method for performing checklist procedures in an industrial environment.

### SUMMARY

A digital checklist system includes an electronic calibration and measurement device and a computer-readable medium having computer-executable instructions stored thereon that, if executed by one or more processors of a computing device, cause the computing device to perform actions for managing a digital checklist The actions include creating a digital checklist having at least one unique prompt, selecting the digital checklist for uploading onto the electronic calibration and measurement device, and downloading data input into the electronic calibration and measurement device in response to the at least one unique prompt. The system further includes a network location for facilitating communication between the electronic calibration and measurement device and the computing device.

This summary is not intended to limit the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an exemplary pictorial depiction of a networking environment for carrying out aspects of the present disclosure, wherein the networking environment includes a documenting process calibrator, a host server, and a site server/workstation;

FIG. 2 is an exemplary pictorial depiction of computer architecture for the host server or the site server/workstation;

FIG. 3 is an exemplary flow diagram of a method for implementing a digital checklist;

FIG. 4 is an exemplary graphical user interface of a first portion of a digital checklist;

FIG. 5 is an exemplary graphical user interface of a second portion of a digital checklist;

FIG. 6 is an exemplary graphical user interface of a third portion of a digital checklist;

FIG. 7 is an exemplary graphical user interface of a fourth portion of a digital checklist;

FIG. 8 is an exemplary graphical user interface of a fifth portion of a digital checklist;

FIG. 9 is an exemplary graphical user interface of a sixth portion of a digital checklist;

FIG. 10 is an exemplary graphical user interface of a seventh portion of a digital checklist; and

FIG. 11 is an exemplary graphical user interface of a seventh portion of a digital checklist.

### DETAILED DESCRIPTION

The present disclosure is directed to a system for a digital checklist used to carry out a list of tasks, and a method for implementing the digital checklist for use in an industrial plant or manufacturing environment. Aspects of the present disclosure will be hereinafter described with reference to a digital checklist implemented on a documenting process calibrator. However, it should be appreciated that the device and method described below can be used with any suitable electronic device or product other than a DPC. Moreover, the steps for performing the method, as well as the means for implementing the method, may be modified, rearranged, and/or combined with any other steps without departing form the spirit and scope of the present disclosure.

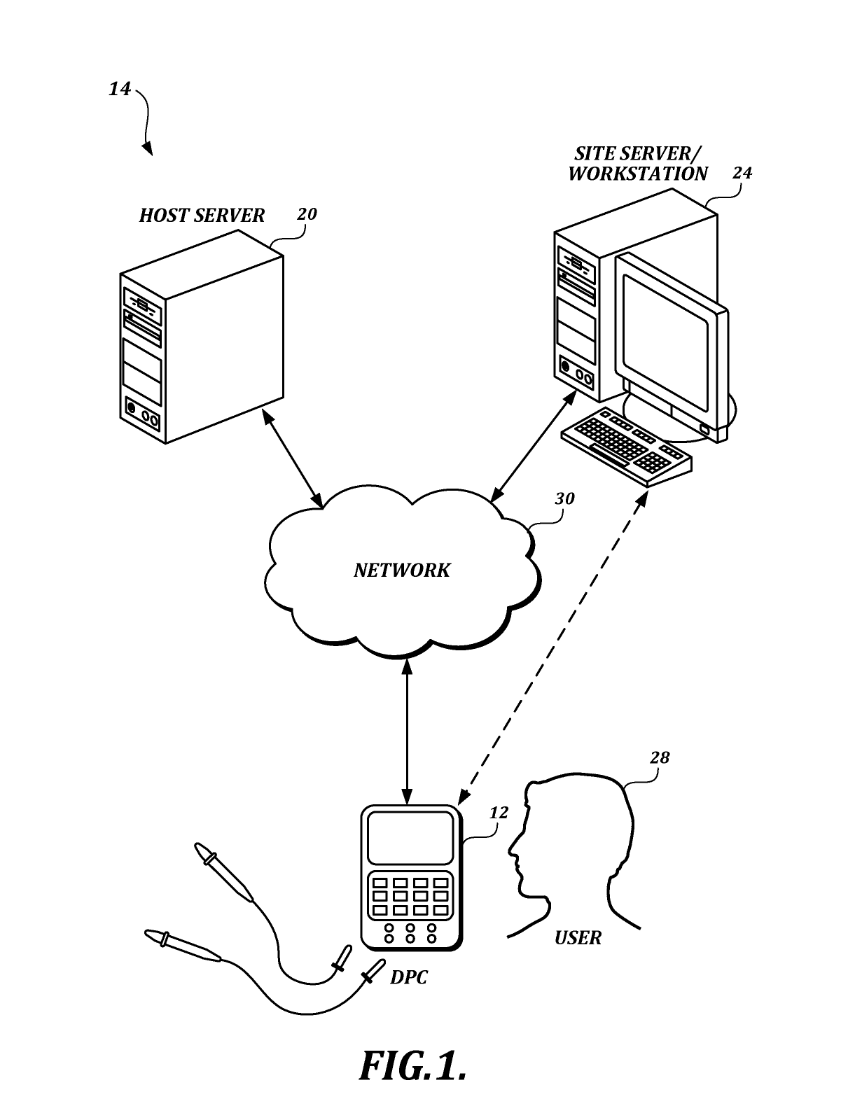

Referring to FIG. 1, an exemplary pictorial depiction of an electronic calibration and measurement device, such as a documenting process calibrator (DPC) 12, in communication with a networking environment 14 is shown. The DPC 12 is a multifunction device that can be used in harsh or dangerous industrial environments to measure and calibrate various devices, instruments, systems, etc. Any suitable DPC, such as a 750 Series Fluke documenting process calibrator, available from Fluke Corporation of Everett, Wash., may be used. The DPC 12 may be placed into communication with a computer or similar device for uploading checklist tasks and other procedures. Once the digital checklist tasks and results are captured in the DPC 12, the DPC 12 may again be placed into communication with a computer or similar device for downloading the results for storage and archive.

A brief, general description of a networking environment 14 suitable for carrying out aspects of the digital checklist and the method for implementing the digital checklist will now be described. It should be appreciated that the networking environment 14 hereinafter described is provided for illustrative purposes only. Moreover, although specific system configurations are illustrated, it should be understood that examples provided herein are not exhaustive and do not limit the present disclosure to the precise forms disclosed. Persons having ordinary skill in the field of computers will recognize that components described herein may be interchangeable with other components or combinations of components and still achieve the benefits and advantages of the disclosed digital checklist and method for implementing the digital checklist. Furthermore, the computer components hereinafter described may be grouped in a single location or distributed over a wide area.

The networking environment 14 is comprised of a plurality of computers, namely, the host server 20, the site server/workstation 24, and the DPC 12, wherein the DPC 12 is shown associated with a user 28. The host server 20 and the site server/workstation 24 are configured to communicate with each other and with the DPC 12 via a network 30, which may be implemented as a local area network (“LAN”), a wide area network (“WAN”), or the global network commonly known as the Internet. As known to those skilled in the art and others, the computers 20 and 24 and the DPC 12 illustrated in FIG. 1 may be configured to exchange files, commands, and other types of data over the network 30. However, since protocols for network communication such as TCP/IP are well known to those skilled in the art of computer networks, those protocols will not be described herein.

The functions performed by each of the computers described with reference to FIG. 1 may instead be implemented by a plurality of computers. For example, while the host server 20 is illustrated as a single computer, single-based functionality is frequently handled in a “server farm” in which multiple servers cooperate in executing necessary tasks so that requests from potentially large numbers of users may be satisfied. Moreover, in addition to the conventional computer systems illustrated in FIG. 1, those skilled will recognize that the present method may be practiced on other kinds of computers, including laptop computers, tablet computers, personal digital assistants (“PDAs”), or any other suitable device in which computer software or other digital content may be executed.

In the context of FIG. 1, the host server 20 may be configured to generate and store digital checklist programs and files for upload and use on the DPC 12. The digital checklist programs and files are accessible by uploading programs and/or files from the host server 20, by accessing programs/files through a shared library, or through a Web-based program accessible on the site server/workstation 24.

The site server/workstation 24 includes suitable programs for accessing the digital checklist programs and files from the host server 20 over the network 30. An operator may access the digital checklist program/file on the site server/workstation 24 to retrieve, modify, and/or build customized digital checklist programs and files for downloading onto the DPC 12. It should be appreciated that the digital checklist programs and files may instead be stored locally on the site server/workstation 24 as well as any modified or customized digital checklist programs, for uploading and use on the DPC 12.

The DPC 12 includes suitable hardware and firmware for uploading the digital checklist programs and files onto the DPC 12. The DPC 12 may be placed into communication with the site server/workstation 24 though a serial or RS 232 port, a USB connection, or other wired means, through a wireless connection, or by other suitable means.

The DPC 12 also includes suitable hardware and firmware for running the digital checklist programs and files on the DPC 12, and thereafter uploading the completed/modified digital checklist file onto the site server/workstation 24 for archive and storage. The completed digital checklist file may either be stored locally on the site server/workstation 24, or instead stored on the host server 20.

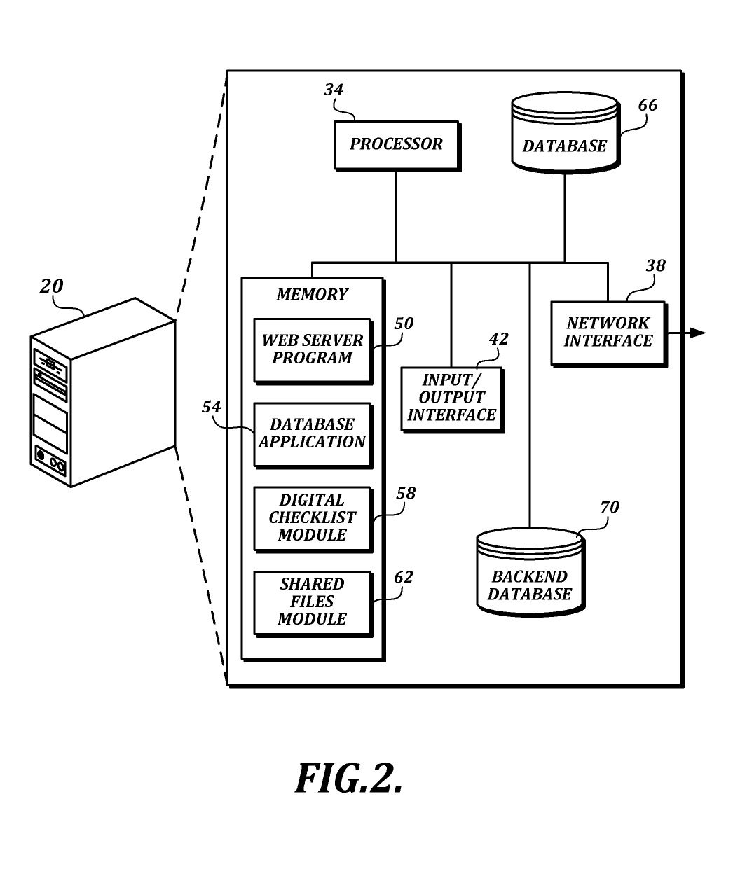

Referring to FIG. 2, an exemplary architecture of the host server 20 depicted in FIG. 1 that illustrates computer components suitable to implement aspects of the present method will be described. Those skilled in the art and others will recognize that the host server 20 illustrated in FIG. 1 may be any one of a variety of devices, including, but not limited to, personal computing devices, server-based computing devices, mini and mainframe computers, laptops, or other electronic devices having some type of memory. In the embodiment illustrated in FIG. 2, the host server 20 includes a processor 34 in communication with a variety of computing elements, including a network interface 38, an input/output interface 42, and a memory 46.

The network interface 38 depicted in FIG. 2 enables the host server 20 to communicate data, control signals, requests, and other information via a communication network (LAN, WAN, Internet, etc.) such as the network 30 described above with respect to FIG. 1. For instance, the host server 20 may receive requests from other networked computers and transmit data back to a requesting computer using the network interface 38.

The input/output interface 42 enables the host server 20 to communicate with various local input and output devices. An input device in communication with the input/output interface 42 may include computing elements that provide input signals to the host server 20, such as a keyboard, mouse, external memory, disc drive, etc. Also, an output device in communication with the input/output interface 42 may include computing elements that accept output signals such as a monitor, a printer, and the like.

The processor 34 is configured to operate in accordance with computer program instructions stored in a memory, such as the memory 46. In some computing systems, program instructions may also be embodied in a hardware format, such as a programmed digital signal processor. In any event, as illustrated in FIG. 2, the memory 46 stores a Web server program 50, a database application 54, a digital checklist module 58, and a shared files module 62.

The Web server program 50 illustrated in FIG. 2 comprises computer-executable instructions that, when executed by the processor 34, generates configurable markup documents (hereinafter referred to as “Web pages”). The Web server program 50 provides a way for the host server 20 to interact with users of other network-accessible computers. For example, the Web server program 50 is configured to generate Web pages and cause markup code form Web pages to be accessible from the network 30. When a Web page is accessed, the Web server program 50 may receive data back from a network computer that describes the user's interactions with the Web page. In accordance with one embodiment of the presently disclosed method, the content of the Web pages generated by the Web server program 50 serve as an interface that enables users to create, modify, and access digital checklist programs for downloading onto the DPC 12. Moreover, the content of the Web pages generated by the Web server program 50 serve as an interface that enable users to upload data to a database 66, and access any stored data within the database 66 and/or a back end database 70.

The Web server program 50 also interacts with other computer components illustrated in FIG. 2 so that the appropriate data may be obtained from or communicated to a user. For example, a request to create a customized digital checklist file may be received form a user. In this instance, data associated with the request is received at the Web server program 50 and it is forwarded to the digital checklist module 58 so that the digital checklist module 58 may be run to create a customized digital checklist file.

In another instance, a request to upload a completed digital checklist file from the DPC 12 (through the site server/workstation 24) may be received from a user. In such an example, data associated with the request is received at the Web server program 50 and forwarded to the database application 54 so that the database 66 may be updated. In that regard, when a request to retrieve completed checklist data or a customized checklist file is received from a user, the data associated with the request is received at the Web server program 50 and forwarded to the database application 54 so that the database 66 may retrieve the data or file. As can be appreciated from the foregoing, the database application 54 provides mechanisms for updating and/or retrieving data stored in the database 66 such that a user may retrieve or upload data associated with a corresponding digital checklist file through a digital checklist Web site. The database application 54 may also be suitable for authenticating the user and/or electronic signature such that archived data may only be retrieved by authorized personnel.

The Web server program 50 may also interact with the database application 54 to retrieve data from a back end database 70 that stores data necessary to provide Web pages for enabling users to create and access digital checklist programs and files, for enabling users to upload data from completed digital checklist files, and for enabling users to retrieve data from previously stored completed digital checklist files. It should be appreciated that the database 66 and back end database 70 may instead be combined into one database, or instead, additional databases may be used.

In addition or as an alternative to the Web server program 50, a shared files module 62 may be included for providing remote access to the digital checklist programs and files created by the digital checklist module. The shared files module 62 could be configured as a Dynamic Link Library (DLL) or any other suitable configuration to provide an interface on the site/server workstation 34 for downloading and retrieving files on the DPC 12.

As noted above, the digital checklist programs and files may alternatively be stored locally on the site server/workstation 24. In that regard, the site server/workstation 24 may communicate directly with the DPC 12 through wired or wireless means without the use of a network. In this alternative embodiment, the site server/workstation 24 may include computer components similar to those of the host server 20 described above with respect to FIG. 2. For instance, the digital checklist module 58 would be stored locally on the site server/workstation 24 for creating customized digital checklist files, accessing created digital checklist files, modifying digital checklist files, etc. Moreover, the database application 54 would be configured to store and retrieve digital checklist data locally in the database 66 and/or the backend database 70.

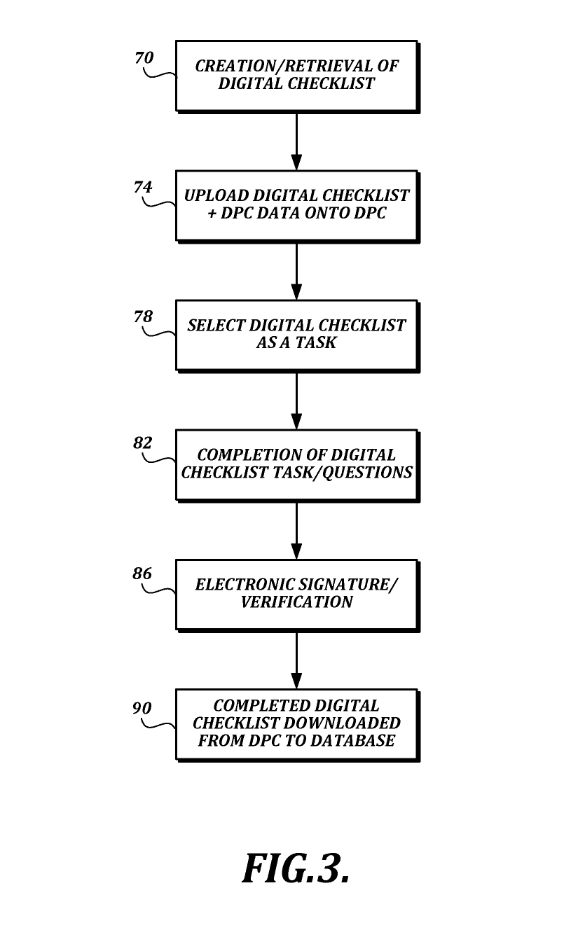

Referring to FIG. 3, the digital checklist used to carry out a list of tasks, and the method for implementing the digital checklist will now be described. The compilation of digital checklist programs, files, etc. (hereinafter collectively referred to as the “digital checklist”) are created by the digital checklist module 58, as indicated by block 70, which may be configured to include one or more template checklists that can be customized for the intended use. A user accesses the digital checklist module 58 through the site server/workstation 24 by interfacing the Web server program 50 or the shared files module 62 (or directly on the site server/workstation 24 if the digital checklist module 58 is installed locally). With the use of the digital checklist module 58, a customized digital checklist having a unique series of prompts, questions, tasks, etc., (hereinafter collectively referred to as the “prompts”) is created. The digital checklist module 58 is similarly used to modify a digital checklist template or retrieve an earlier created digital checklist.

The digital checklist module 58 may access the database 66 to retrieve stored information about the DPC 12 on which the digital checklist will be executed. Such information may include information for the DPC 12 (“DPC data”), such as, for instance, the DPC input/output range for one or more measurements, the test tolerance, tag and serial number, procedure information and details, past calibration and test results, etc. The DPC data may be pulled from the database 66 to assist in populating certain information, questions and tasks in the checklist For instance, referring to FIG. 5, when selecting the checklist to perform on the DPC 12, the checklist may list the serial number and model of the DPC, any precautionary notes, a summary of past results, etc.

Once the digital checklist has been created, modified, or retrieved, the selected digital checklist is uploaded onto the DPC 12 from the site server/workstation 24, as indicated by block 74. The digital checklist populates the DPC 12 with a plurality of prompts that need to be viewed by or completed by the user.

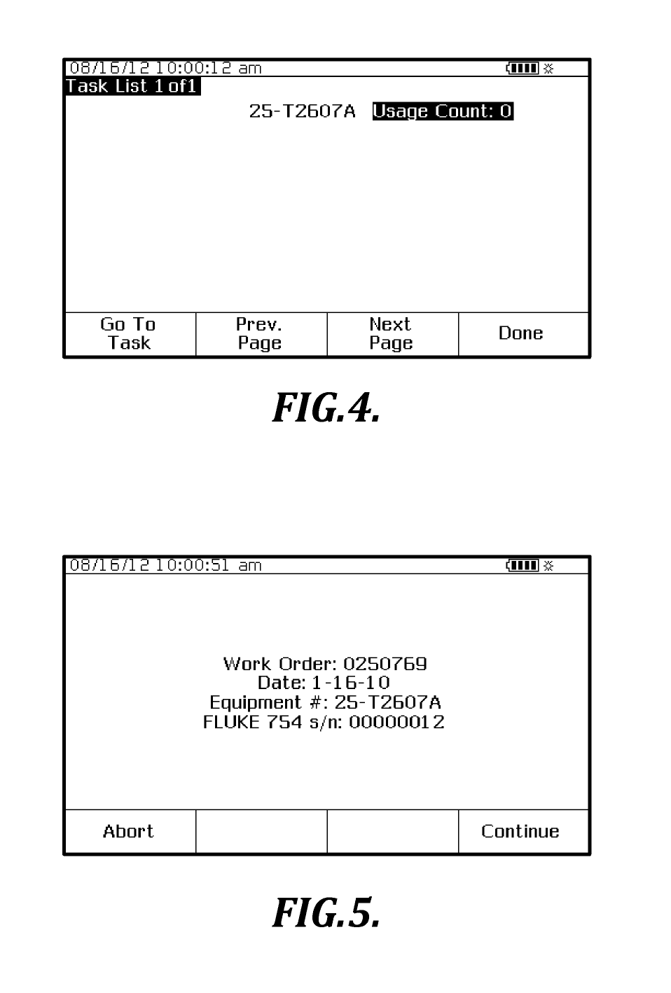

Once uploaded onto the DPC 12, the digital checklist is selectable as a prompt, as indicated by block 78, and as shown in FIG. 4. The DPC 12 may include any suitable graphical user interface (“GUI”) for displaying the checklist and its associated prompts, such as the exemplary GUI shown in FIGS. 4-11. The GUI may display the prompts with suitable control devices, such as buttons, drop down lists, check lists, radio buttons, etc. The DPC 12 may also include a suitable input assembly for inputting information through one of the control devices displayed on the GUI. For instance, the input assembly may include a keyboard for entering information, a touchscreen, voice command technology, or any other suitable technology now known or later developed. After the digital checklist is selected, the checklist prompts are viewed by and/or completed by the user, as indicated by block 82. Although each digital checklist may be unique and configured for use in a specific situation, prompts of an exemplary digital checklist will now be described with reference to FIGS. 4-11.

Referring to FIG. 4, the user may power on the DPC 12 and access the appropriate menu for selecting the digital checklist to be carried out on the DPC 12. The desired digital checklist may be selected either from a list of checklists or as the sole option. The selection may be made in any suitable manner. For instance, the checklist may be selected by highlighting the checklist and then highlighting “OK” or “Next Page” to continue onto the digital checklist tasks.

Referring to FIG. 5, upon selection of the desired digital checklist, the DPC 12 may display information about the DPC being used, such as the model and serial number. The DPC 12 may further display the digital checklist reference or work number, the date the checklist is being performed, the equipment to be tested, and any other pertinent information relevant to the user. Upon viewing this information, the user can proceed to the next screen by clicking or highlighting “Continue” or “OK.”

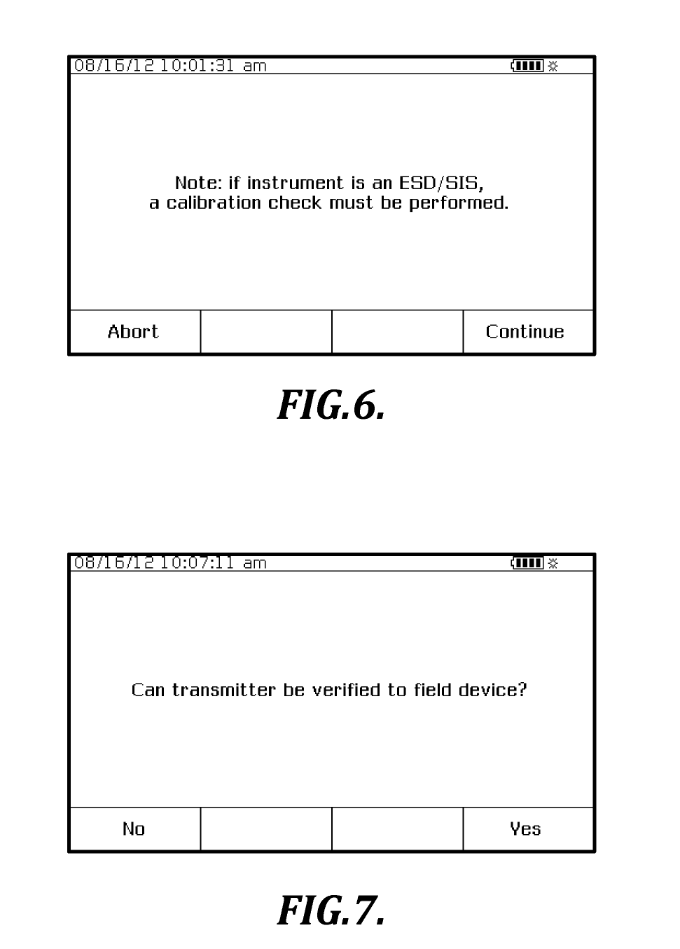

Referring to FIG. 6, any notes, alerts, or precautions regarding the tasks to be performed may be displayed. For instance, certain precautionary calibration steps may need to be performed on certain equipment, and if so, the checklist may need to be aborted to first complete these tasks. To abort the checklist, the user can click or highlight “Abort.” If the precautionary note can be disregarded, the user can proceed to the next screen by highlighting “Continue” or “OK.” It should be appreciated that the user may exit the digital checklist for completion at a later time or date by clicking “Abort” at any time.

Referring to FIG. 7, the DPC 12 may prompt the user to answer a question by selecting one or more of a plurality of answers, such as by selecting either “Yes” or “No.” Upon selecting an answer, the DPC 12 will display a preselected prompt that corresponds to the answer selected. In other words, the digital checklist has branching capability to direct the user to a corresponding prompt/task/question (while skipping any irrelevant prompt/task/question). Thus, in the present example, the digital checklist prompts the user to answer the question “can transmitter be verified to field device?” by selecting “No” or “Yes.”

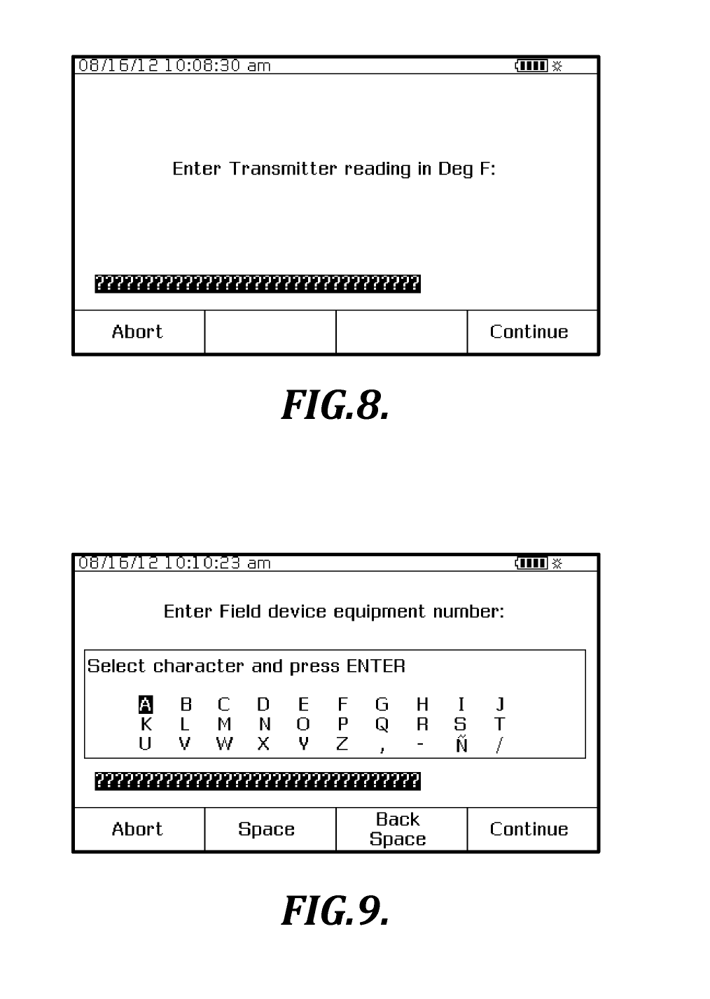

If the user answers “No,” the user will be directed to a prompt in another section of the checklist If the user answers “Yes,” the user will be directed to additional prompts in that section. For instance, as shown in FIG. 8, after answering “Yes,” the user is prompted to enter information about the transmitter temperature, and in FIG. 9, the user is prompted to enter the field device equipment number.

The branching capability of the digital checklist streamlines the checklist process for the user. It also increases the flexibility of the digital checklist, as opposed to a written form which must capture all the possible answers and all the possible follow up questions and tasks.

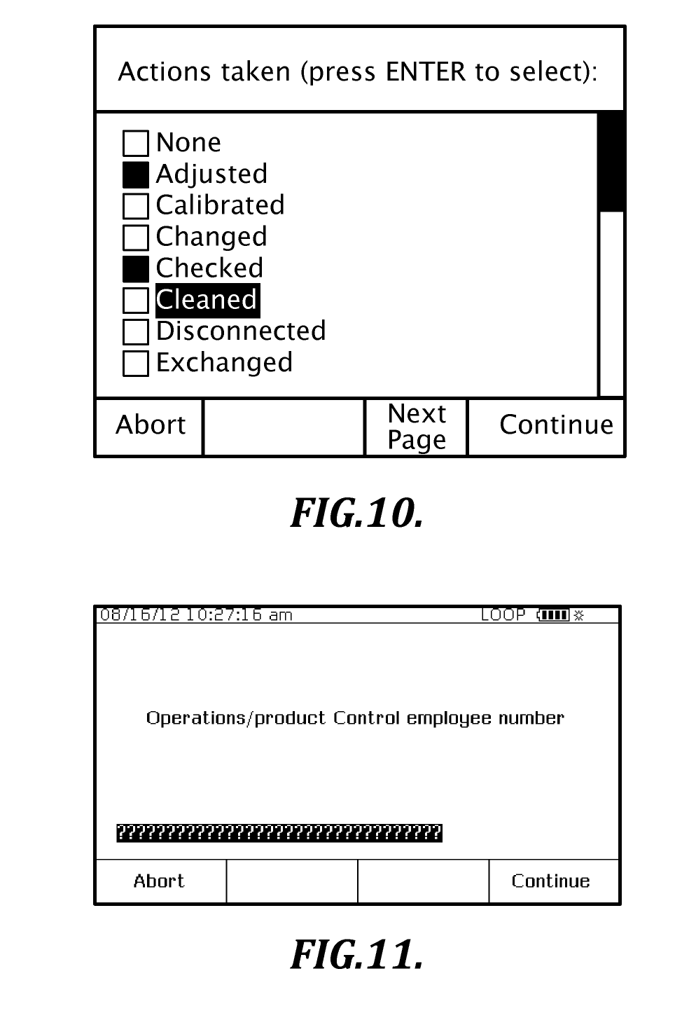

Referring to FIG. 10, the DPC 12 may prompt the user, after completing one or more tasks, to choose what action or actions have been taken with respect to the equipment. The prompt will request the “actions taken,” and provide a multiple choice list of answers for the user to choose from. To choose an answer, the user may scroll through the list (using up/down arrows, a scroll wheel, etc.), and select the desired answer(s) by pressing “Enter” when the answer is highlighted, by physically touching the radio button adjacent the answer (with, for instance, a touchscreen device), or by another suitable method.

Once the user reaches the end of the digital checklist by responding to all the prompts, the user may be required to enter a unique identification code or number to “digitally sign” the checklist, as shown in FIG. 11. Such a code or number may act as an electronic signature and verification that authorized personnel completed the checklist Moreover, once the checklist data is archived, the electronic signature may be stored with the checklist for tracking, retrieval, and auditing purposes.

Referring back to FIG. 3, the digital checklist data, once completed, may be downloaded from the DPC 12 to the site/server workstation 24 in any suitable manner, such as through wired or wireless means. The checklist data may be stored locally on the site/server workstation 24 and/or uploaded onto the host server 20 through the shared files module 62 and/or the Webs server program 50. The database application 54 may include suitable software for archiving, retrieving, and managing checklist data once uploaded to the host server 20.

While the preferred embodiment of the invention has been illustrated and described, it will be appreciated that various changes can be made therein without departing from the spirit and scope of the present disclosure.

The embodiments of the present disclosure in which an exclusive property or privilege is claimed are defined as follows:

1. A digital checklist system, comprising:
(a) an electronic calibration and measurement device;
(b) a computer-readable medium having computer-executable instructions stored thereon that, if executed by one or more processors of a computing device, cause the computing device to perform actions for managing a digital checklist, the actions comprising:
(i) creating a digital checklist having at least one unique prompt; and
(ii) selecting the digital checklist for uploading onto the electronic calibration and measurement device; and
(iii) downloading data input into the electronic calibration and measurement device in response to the at least one unique prompt; and
(c) a network location for facilitating communication between the electronic calibration and measurement device and the computing device.

2. The system of claim 1, wherein the actions further comprise retrieving a digital checklist from a database.

3. The system of claim 1, wherein the actions further comprise accessing a database to retrieve information about the electronic calibration and measurement device.

4. The system of claim 3, wherein the actions further comprise modifying the digital checklist to include information about the electronic calibration and measurement device.

5. The system of claim 1, wherein the actions further comprise accessing a database to retrieve a template for creating the digital checklist.

6. The system of claim 1, wherein the electronic calibration and measurement device is a documenting process calibrator.

7. The system of claim 1, wherein the electronic calibration and measurement device is configured to display the at least one unique prompt of the digital checklist.

8. The system of claim 7, wherein the electronic calibration and measurement device includes an input assembly for inputting data in response to the at least one unique prompt.

9. The system of claim 7, wherein the digital checklist includes at least first, second, and third unique prompts, and wherein the actions further comprise configuring the digital checklist such that, when uploaded onto the electronic calibration and measurement device, the user's input in response to the first unique prompt causes the electronic calibration and measurement device to display one of either the second and third prompts.

10. The system of claim 7, wherein the actions further comprise storing the downloaded data input into the electronic calibration and measurement device in response to the at least one unique prompt in a database.

11. A method for implementing a digital checklist on an electronic calibration and measurement device, the method comprising:
(a) creating a digital checklist having at least one unique prompt;
(b) selecting the digital checklist for uploading onto an electronic calibration and measurement device;
(c) displaying the at least one unique prompt on the electronic calibration and measurement device;
(d) inputting data into the electronic calibration and measurement device in response to the at least one unique prompt; and
(e) downloading the data the electronic calibration and measurement device.

12. The method of claim 11, further comprising retrieving a digital checklist from a database.

13. The method of claim 11, further comprising accessing a database to retrieve information about the electronic calibration and measurement device.

14. The method of claim 13, further comprising modifying the digital checklist to include information about the electronic calibration and measurement device

15. The method of claim 11, further comprising accessing a database to retrieve a template for creating the digital checklist.

16. The method of claim 11, wherein the electronic calibration and measurement device is a documenting process calibrator.

17. The method of claim 11, wherein the electronic calibration and measurement device includes an input assembly for inputting data in response to the at least one unique prompt.

18. The method of claim 11, further comprising creating at least first, second, and third unique prompts for the digital checklist, and configuring the digital checklist such that, when uploaded onto the electronic calibration and measurement device, the user's input in response to the first unique prompt causes the electronic calibration and measurement device to display one of either the second and third prompts.

19. The method of claim 11, further comprising storing the downloaded data input into the electronic calibration and measurement device in response to the at least one unique prompt in a database.

20. A digital checklist system, comprising:
(a) an electronic calibration and measurement device;
(b) a first computing device configured to be communicatively coupled to the electronic calibration and measurement device, the first computing device configured to:
(i) select a digital checklist for uploading onto the electronic calibration and measurement device, the digital checklist having at least one unique prompt; and
(ii) download data input into the electronic calibration and measurement device in response to the at least one unique prompt.
